(19) United States
(12) Patent Application Publication
(10) Pub. No.: US 2025/0167482 A1
(43) Pub. Date: May 22, 2025

(54) ELECTRIC PLUG CONNECTOR AND METHOD FOR INSTALLING AN ELECTRIC PLUG CONNECTOR

(71) Applicant: Rosenberger Hochfrequenztechnik GmbH & Co. KG, Fridolfing (DE)

(72) Inventors: Marcel VOLKMAR, Fridolfing (DE); Thomas MIEDL, Fridolfing (DE)

(21) Appl. No.: 18/839,114

(22) PCT Filed: Mar. 1, 2023
(86) PCT No.: PCT/EP2023/055096

§ 371 Date: Aug. 16, 2024

(30) Foreign Application Priority Data
Mar. 2, 2022 (DE) 10 2022 104 959.0

(51) Int. Cl. H01R 13/502; H01R 43/20

(52) U.S. Cl. CPC H01R 13/502; H01R 43/20

(57) ABSTRACT

The invention relates to an electric plug connector (1), in particular an angled plug connector, having at least one electric contact element (8), a plug connector housing (2) comprising multiple chambers (6, 7) which run adjacently to one another and which can be populated with the contact elements (8), and a support assembly (15), wherein at least one of the chambers (6, 7) is populated with one of the contact elements (8) such that a rigid longitudinal section (L_{S}) of the contact element (8) rests against the inner face of the populated chamber (6) at an axial contact position (P_{A}). The support assembly (15) has at least one support element (14) which can be fitted into the unpopulated chamber (7) of the plug connector housing (2) instead of one of the contact elements (8), and the support element (14) is arranged adjacently to the at least one populated chamber (6) in at least one additional unpopulated chamber (7) instead of a contact element (8) in order to support the unpopulated chamber (7) from the inner face at at least one axial support position (P_{S}). The axial support position (P_{S}) is arranged at least substantially at the same axial position as the axial contact position (P_{A}) of the adjacent populated chamber (6).

The present application claims the priority of German patent application no. 10 2022 104 959.0, the content of which is fully incorporated herein by reference.

The invention relates to an electric plug connector that comprises a plug connector housing with multiple chambers running side by side that can be equipped with contact elements, according to the preamble of claim 1.

The invention further relates to a method for assembling an electric plug connector, in particular an angled plug connector.

Various electric plug connectors are known from the field of electrical engineering. As is commonly known, electric plug connectors are used to transmit electrical power signals and/or data signals to corresponding mating plug connectors. A plug connector or mating plug connector may be a plug, a printed circuit board plug connector, a built-in plug connector, a socket, a coupling or an adapter. The term “plug connector” or “mating plug connector” used within the scope of the invention stands for all variants.

Electric plug connectors often have multiple contact elements in a common plug connector housing. The contact elements are usually distributed between different chambers in the plug connector housing, in which they are individually guided and fixed. Frequently in this case, particularly with plug connectors for high-frequency technology, contact elements arranged coaxially to one another are also provided in a common chamber (i.e. usually an outer conductor contact element through which a central inner conductor contact element runs, spaced apart by an insulator).

Since electric plug connectors sometimes need to be produced in large quantities as part of mass production and therefore, in particular, also need to be capable of being manufactured particularly economi-cally, the use of a modular plug connector housing, the chambers of which are only equipped with contact elements as needed, has proved particularly suitable. The same plug connector housing can therefore be reused for many different applications (the so-called common parts principle).

At times, a plug connector must withstand high mechanical loads, and it must be ensured that the plug connector is not damaged and the electrical connection is not accidentally disconnected. It is also important to avoid short circuits between contact elements of the plug connector insofar as possible. High requirements are particularly placed on the robustness and safety of plug connectors for the automotive industry or for vehicles. For example, in the case of electromobility and the autonomous operation of vehicles and for driver assistance systems, ensuring safety is paramount.

Against this background, it has been shown that, in particular, the mechanical forces acting on a cable of a cable plug connector during operation or assembly can cause critical transverse forces within the plug connector housing. The contact elements within the equipped chambers then sometimes transfer high forces into the partition walls between the chambers of the plug connector housing. Insofar as individual chambers remain unequipped, the partition walls involved within the chamber receive no mechanical support, which can lead to the partition wall breaking and/or the contact element in the adjacent, equipped chamber bending.

In order to avoid this problem, high requirements in terms of transverse tensile strength and housing robustness must be considered when designing the plug connector housing, which quite significantly influ-ences the size ratios and geometric features of the plug connector housing.

Sometimes (for example during the autonomous operation of a vehicle or when using assistance systems) large amounts of data need to be transmitted by means of the plug connection. At the same time, it is sometimes important to design the plug connectors as compactly as possible to save installation space and weight, leading to a conflict of objectives if the plug connector housing needs to be fitted with thicker walls to support the unequipped chambers, for example.

Therefore, there is a particular need for a compact and simultaneously robust, cost-effective, and modularly manufacturable electric plug connector.

In view of the known state of the art, the object of the present invention is to provide a support arrangement for an electric plug connector that allows the robustness, in particular the transverse tensile strength, of the plug connector to be increased.

The present invention is also based on the object of providing an electric plug connector that has high robustness, in particular transverse tensile strength, and can preferably be manufactured particularly eco-nomically in the context of mass production.

Furthermore, the object of the invention is to provide a method for assembling an electric plug connector, in particular for assembling an electric plug connector in the context of mass production, in which robust plug connectors can be manufactured, preferably modularly, using common parts.

The object is achieved for the electric plug connector with the features listed in claim 1. In relation to the method, the object is achieved by claim 15.

The dependent claims and the features described below relate to advantageous embodiments and variants of the invention.

A support arrangement for an electric plug connector is provided, which has a plug connector housing with multiple chambers running side by side that can be equipped with contact elements.

The invention is particularly suitable for use with cable plug connectors, in particular with angled cable plug connectors. However, the invention is suitable in principle for use with any plug connectors, so also with board plug connectors and non-angled plug connectors, for example.

The plug connector housing is preferably made of an electrically non-conductive material, particularly plastic. The plug connector housing can be designed as a single piece or multiple pieces. The plug connector housing can have any features typical of plug connectors (e.g. locking and securing elements for connection to a corresponding mating plug connector, sealing elements for protection against dirt and liquids, etc.), which are generally already known in the art, which is why further examples and details will be omitted.

The chambers for receiving the contact elements are preferably mainly elongate and usually run at least substantially in a straight line to receive a straight, elongate section of the contact elements.

On the inner side of the chamber, fastening means can be provided for securing the contact elements, particularly locking means such as recesses, projections, and spring tabs. In particular, a press-fit connection or an interference fit between the contact element and the chamber can also be provided. Any form-fitting and/or force-fitting attachment of the contact elements in the chambers of the plug connector housing can be provided.

The chambers preferably run immediately adjacent to, and parallel to, one another, wherein a common partition wall or a primarily thin housing section separating the two adjacent chambers is provided between adjacent chambers. Corresponding plug connector housings with individual chambers for receiving contact elements are generally known in the art, which is why further details in this regard will also be omitted.

Hereinafter, chambers of the plug connector housing equipped with a contact element will be referred to as “equipped chambers,” whereas chambers of the plug connector housing not equipped with a contact element will be referred to as “unequipped chambers” (even if the support elements mentioned below are still received in the unequipped chambers). The terms “equipped”/“unequipped” therefore specifically relate to equipping with a contact element.

Relative directional indications such as “front” or “back” are sometimes used below in the interests of simplicity. The term “front” in this case refers to the connection section (the “interface”) of the plug connector intended for connection to the mating plug connector (so on the “plug side”), whereas the term “back” refers to the rear side of the plug connector facing away from the connection section or the plug side.

According to the invention, the support arrangement comprises at least one support element that can be inserted into an unequipped chamber of the plug connector housing instead of one of the contact elements.

The outer geometry of the at least one support element can be designed in such a manner that the support element can be inserted into a corresponding chamber from the front or back. Securing (e.g. latching or pressing) the support element in the chamber is not necessarily required in this case but is optionally possible.

According to the invention, the support element is designed to support the unequipped chamber from the inside on at least one axial support position.

The support can preferably be achieved in that the support element rests at least sectionally against an inner side of the chamber (e.g. on the partition wall to the adjacent, equipped chamber) with its outer surface or the support surfaces mentioned below.

Multiple axial support positions can also be provided, in particular. It is generally advantageous if the support element supports the unequipped chamber along at least one continuous axial support section (or multiple axial support sections spaced apart from one another). However, a point or (partially) circular ring-shaped support at an axial support position may also be sufficient in principle.

The support of the chamber by the support element can be limited to, or focused on, axial sections or axial positions where the highest mechanical load is expected. Therefore, the support element may possibly also extend only partially through the chamber and also support the chamber only in sections, particularly in order to save material for the support element.

Insofar as the present description refers to an axial position or an axial section, this position is particularly understood to be in relation to the longitudinal axis of the plug connector in the region of the chambers.

Advantageously, by using the proposed support arrangement, plug connector housings of an electric plug connector can be used modularly and variably equipped with contact elements. The support elements provided in the unequipped chambers ensure that the robustness, particularly the transverse strength, of the plug connector housing is not adversely reduced. Therefore, additional structural reinforcement measures, such as additional braces, material adjustments or thickening within the plug connector housing, can be omitted.

Due to the use of the support elements, a small plug connector housing with delicate partition walls between the individual chambers can be used even for mechanically highly stressed applications and can be modularly equipped as needed.

In an advantageous development of the invention, it may be provided that the outer geometry of the support element differs from the outer geometry of at least one contact element of the plug connector in its design.

In particular, it can be provided that the outer geometry of the support element is functionally different from the outer geometry of a contact element. The support elements and the contact elements therefore preferably differ based on functional geometric features, such as locking means and contact sections for resting against the inner side of the chambers, for example.

For example, it may be provided that the contact elements are designed to be force-fitted and/or form-fitted in the chamber, whereas the support elements do not have fastening means of this kind for fastening within the chamber.

In particular, it may also be provided that the support element is shorter along its longitudinal extent than at least one contact element of the plug connector. The support elements therefore preferably project less deeply into the chamber than the contact elements, even when fully mounted.

A support element is preferably not a contact element. A support element is also preferably not a so-called dummy contact element, i.e. a non-functional contact element partially made of plastic. For cost reasons, it is preferable to avoid equipping the unequipped chambers of the plug connector housing with blind (i.e. unconnected) or dummy contact elements (i.e. replicas of contact elements).

According to a development of the invention, it can be provided that the cross section of the support element decreases towards at least one of its ends to form a centering tip for easier insertion of the support element into the corresponding chamber.

The centering tip is preferably formed at the front end of the support element, i.e. at the end facing the mating plug connector (when the support element is mounted in the chamber). This can simplify the insertion of the support element into the corresponding chamber from the rear. If the support element is to be inserted into the chamber from the front, the rear end of the support element can also have the centering tip, however.

The centering tip preferably has a blunt end, meaning that it is not fully pointed.

The reduction in the cross section of the support element towards the centering tip can be stepped or continuous.

The support element is preferably made of a dielectric material, particularly plastic. The support element may be a plastic injection-molded part, for example.

In principle, however, the support element can also be made of an electrically conductive material, particularly a metal. The support element may, for example, be manufactured as a stamped and bent part from sheet metal.

According to a development of the invention, the support element can be designed as a solid body, particularly when the support element is made of plastic.

Particularly if the support element is made of metal, said support element can, however, also be designed alternatively as a hollow body, for example a hollow cylinder, in order to save material, insofar as the mechanical strength of a hollow body of this kind is still sufficient for the function of supporting the support element.

In a development of the invention, it may be provided that the support element has one or multiple support surfaces arranged distributed along the circumference of the support element for supporting the unequipped chamber from the inside, which support surfaces are designed to rest against the inside (particularly an inner wall/partition wall to an adjacent chamber) of the unequipped chamber.

Preferably, at least three support surfaces are provided, arranged distributed along the circumference of the support element, which support surfaces, in a particularly preferred embodiment, can be distributed equidistantly along the circumference of the support element.

The multiple support surfaces can, where necessary, also be positioned at axially different support positions or support sections.

The support surfaces can be formed on the outer surfaces of projections on the support element, for example on the outer surfaces of ribs, webs, or dome-like projections.

It can also be provided that the support element has an external cross-sectional profile that corresponds to the internal cross-sectional profile of the unequipped chamber, or at least corresponds to the extent that the support element can support the chamber accordingly from the inside.

It can therefore be provided that the support element rests against the inside of the chamber at least at the axial support position, preferably at the axial support section, either sectionally or fully circumferential-ly in an annular manner. As mentioned above, a sufficient supporting function can also be achieved, in particular, if the support element only rests against the inside of the chamber sectionally along the circumference, for which said ribs can be provided, for example, distributed along the circumference of the support element.

In a development, it can be provided that the support arrangement has a base body (in particular a plate-shaped base body), from which the at least one support element rises in a dome-like manner or to which the at least one support element is directly or indirectly connected.

The base body and the at least one support element are preferably integrally formed. However, the base body and the at least one support element can also be made in multiple parts, wherein the at least one support element in this case can be fastened to the base body in a bonded, form-fitted, and/or force-fitted manner.

The base body can advantageously form an additional cover cap for the plug connector housing and is also very well suited as an actuation surface for mounting the at least one support element in the plug connector housing.

In one embodiment of the invention, it can be provided that the base body has at least one latching element for latching with the plug connector housing to hold the at least one support element in the chamber in a loss-proof manner.

The fixing of the at least one support element in the corresponding chamber can therefore preferably take place outside the chamber, particularly by means of the base body.

Optionally, multiple support elements can also be axially secured together in the chambers in a loss-proof manner by the base body. The base body can therefore reduce the assembly effort and also the manufacturing effort for the individual support elements.

In a development of the invention, it can be particularly provided that multiple support elements rise from a common base body.

The ease of assembly and also the robustness of the support arrangement can be substantially improved if multiple support elements rise from a common plate-shaped base body, so that they can be assembled in the plug connector housing together.

In order to maintain high modularity, it can be provided that different variants of base body-support element combinations are available. For example, a first variant with a plate-shaped base body with exactly one support element, a second variant with a plate-shaped base body with exactly two support elements, and a third variant with a plate-shaped base body with exactly three support elements. Therefore, de-pending on the intended equipment plan of the plug connector housing, a selection can be made from various base body-support element combination variants to provide the unequipped chambers with support elements.

The invention also relates to an electric plug connector, in particular a cable plug connector and/or angled plug connector, comprising a support arrangement according to the preceding and following descrip-tions. The electric plug connector comprises at least one of the electric contact elements and the plug connector housing.

At least one of the chambers of the plug connector housing is preferably equipped with one of the contact elements, so that a rigid longitudinal section of the contact element rests against an inner wall of the equipped chamber in an axial bearing position.

In an unequipped chamber, particularly adjacent to at least one equipped chamber, one of the support elements is preferably arranged instead of a contact element, in order to support the unequipped chamber from the inside at least at the axial support position. The support position is preferably arranged at least substantially at the same axial position as the bearing position of the adjacent equipped chamber.

Advantageously, therefore, a housing support of the plug connector housing can be enabled by support elements independent of the contact elements.

The support element preferably supports at the same axial position where the rigid longitudinal section of the contact element rests against the inside of the equipped chamber. The axial bearing position and the axial support position of adjacent chambers are therefore preferably identical (with respect to the longitudinal axis of the plug connector). However, a (slight) offset can also be provided if the supporting effect is still sufficient in this case. In particular, it can also be provided that instead of axial support positions and axial bearing positions, corresponding axial bearing regions and support regions are provided, which overlap at least sectionally, preferably completely, with respect to the longitudinal axis of the plug connector.

The rigid longitudinal section of the contact element may, in particular, be a section of the contact element that is sufficiently stiffened to damage the plug connector housing, or the chamber thereof, and/or adjacent chambers, in the event of a mechanical lateral load on the contact element, if there is no support arrangement present. The rigid longitudinal section may, in particular, be an axial section of the contact element that is fully enclosed along the circumferential direction (apart from relatively small openings, for example)—in contrast to a spring basket.

As mentioned earlier, multiple axial support positions and/or axial bearing positions can also be provided, up to preferably one or multiple contiguous axial support sections and/or one or multiple contiguous axial bearing sections. A purely punctiform, linear, partially annular, or annular axial support position and/or bearing position can also be provided within the scope of the invention.

The support surface, with which the support element rests against at least one axial support position and/or the bearing surface or the rigid longitudinal section, with which the contact element rests against the axial bearing position, can be formed by ribs, webs, or other projections or elevations or edges (e.g. a front edge of the contact element or support element).

In addition to the axial support position within the unequipped chamber, an optional secondary support position of the support element can, moreover, be provided directly on an adjacent contact element, particularly if the contact element and the support element each project from their chamber and then run alongside one another in sections. The supporting effect of the support element can once again be substantially increased by direct support of the contact element.

The chambers preferably have a round cross section for receiving a preferably primarily round contact element and/or a preferably primarily round support element. In principle, however, any cross-sectional profiles of the chambers, contact elements, and/or support elements are possible.

The invention can be quite particularly advantageous for use with cable plug connectors, as the cables exiting the plug connector housing can sometimes transfer a high load, particularly high lateral forces, to the contact elements. This is particularly (but not exclusively) true for angled plug connectors with a cable exit arranged at an angle to the connection section or “interface.”

The proposed plug connector can be flexibly and modularly adapted for a plurality of applications, since individual chambers of the plug connector housing can be optionally equipped or not equipped with contact elements. Despite the unequipped chambers, high mechanical stability of the plug connector housing can be ensured because the aforementioned support elements can be received in the unequipped chambers. In this way, the plug connector housing, particularly in the region of the chambers, can also be made thinner where necessary to save material. Due to the provision of support elements in the unequipped chambers, good mechanical stability is still maintained. The proposed support elements or the proposed support arrangement advantageously prevent the tearing or even breaking of the individual chambers or the partitions thereof.

The invention is particularly advantageous for use with coaxial plug connectors. Therefore, the plug connector can preferably be a coaxial plug connector.

In an advantageous development of the invention, it may therefore be provided that the at least one contact element is designed as an outer conductor contact element.

Optionally, an inner conductor contact element can finally also be provided, which extends coaxially through the outer conductor contact element and is preferably spaced apart from the outer conductor contact element within the outer conductor contact element by an insulator. This arrangement of outer conductor contact element, insulator, and inner conductor contact element is also referred to as a “coaxial contact arrangement”. The coaxial contact arrangement can be received together in a respective chamber, wherein the outer conductor contact element is directly fastened in the chamber and the insulator and the inner conductor contact element are usually directly fastened within the outer conductor contact element.

The plug connector according to the invention can be particularly advantageously suitable for high-frequency technology. Therefore, the electric plug connector may preferably be a plug connector for high-frequency technology.

However, the electric plug connector can also be a high-voltage plug connector, where appropriate.

In principle, the contact element can be any contact element, for example, also a simple pin contact or a socket contact.

The contact element preferably has a primarily sleeve-shaped structure, at least in the rigid longitudinal section. In addition to the rigid longitudinal section, the contact element can also preferably have one or multiple spring tabs, in particular a spring basket with one or multiple spring tabs, preferably at the front end facing the mating plug connector.

Particularly if the plug connector is designed as an angled plug connector, the contact element can also have a multipart design. For example, a multipart outer conductor contact element and/or a multipart inner conductor contact element can be provided. The rigid longitudinal section may, in particular, be a connecting region that connects the parts of the multipart contact element. This region is expected to be particularly stiffened and can therefore contribute particularly significantly to introducing mechanical loads into the chamber.

In a development of the invention, it can be provided that all the chambers of the plug connector housing that can be equipped with contact elements have an identical internal geometry, preferably at least a functionally identical internal geometry.

In this way, the principle of identical parts can be developed, so that the contact elements and support elements can be introduced into any chambers in a modular manner. The plug connector housing can therefore be advantageously and flexibly used for a plurality of applications.

Preferably (though not necessarily), it is provided that all unequipped chambers of the plug connector housing are fitted or equipped with a support element.

In an advantageous development of the invention, it can be particularly provided that all chambers of the plug connector housing that can be equipped with contact elements are either equipped with a contact element or have a support element.

It can thereby be ensured that all chambers receive sufficient mechanical stability, either through a contact element or a support element.

In an advantageous development of the invention, it can be provided that the plug connector housing has a connection section for connecting to a corresponding mating plug connector, into which the chambers of the plug connector housing that can be equipped with contact elements open (at the “front” in the plug connector housing).

The support elements can preferably be inserted into the chambers starting from a rear side facing away from the connection section of the plug connector housing (from “behind”). In particular, it can be provided that the plug connector housing has a passage at its rear end facing away from the connection section, in the extension of the chambers, through which the at least one support element can be passed to finally reach the chamber(s).

Assembly starting from behind towards the connection section is usually possible with particular ease. Furthermore, accidental damage to contact elements (e.g. a delicate spring basket), for example if the support element is accidentally inserted into an already equipped chamber by a fitter, can be avoided. By inserting the support elements from the rear, it is also easier to comfortably insert support elements with a shorter length than the contact element into the chamber so that they are spaced apart from the front end of the plug connector housing or from the connection section/the front end of the chamber when fully assembled. A potential blind mating contact element or dummy mating contact element of the mating plug connector can then still penetrate the unequipped chamber from the front, where necessary, even though the support element is already in the chamber.

However, it can also be provided in principle that the support elements can be assembled from the front, i.e. starting from the connection section. This variant is less preferred, however.

In an advantageous development of the invention, it can be provided that the support elements, when fully received in the assigned unequipped chambers, extend at least to the rear end or edge of the plug connector housing, preferably protruding from the respective chambers on the rear side.

In this way, it is particularly possible to assemble the at least one support element without the use of a tool. The at least one support element can therefore be particularly easily inserted into the chamber and, in case of doubt, also removed from the chamber again.

In a development of the invention, it can be provided that a respective chamber equipped with one of the contact elements and the unequipped chamber adjacent to this equipped chamber, which is supported on the inside by the support element, have a common partition wall separating both chambers.

The support arrangement and, in particular, the support elements of the support arrangement preferably do not have a sealing function. The support arrangement is preferably not intended to seal the plug connector or plug connector housing against dirt and liquids, but primarily to stiffen the plug connector housing or increase the transverse tensile strength of the plug connector housing.

The invention also relates to a method for assembling an electric plug connector, in particular an angled plug connector, comprising at least the following method steps:
equipping at least one chamber of a plug connector housing with a contact element, so that a rigid longitudinal section of the contact element rests against at least one axial bearing position on the inside of the equipped chamber; and
positioning a support element instead of a contact element in at least one other, unequipped chamber adjacent to one of the equipped chambers, so that the support element supports the unequipped chamber on the inside at least at one axial support position, which at least substantially corresponds to the axial bearing position of the adjacent, equipped chamber.

The proposed method can provide a plug connector with housing reinforcement that can be modularly equipped with contact elements.

The mechanical properties of the plug connector produced by means of the aforementioned method, particularly with regard to transverse tensile strength and general housing robustness under mechanical load, can be significantly improved compared with the plug connectors known in the art that can be modularly equipped.

As already mentioned, the invention is not to be understood as being limited to a specific type of plug connector. However, the invention is particularly suitable for plug connectors for high-frequency technology. Plug connectors of the type PL, BNC, TNC, SMBA (FAKRA), SMA, SMB, SMS, SMC, SMP, BMS, HFM (FAKRA-Mini), H-MTD, BMK, Mini-Coax, or MATE-AX can be provided for use with the invention, particularly designed as angled cable plug connectors.

Features described in connection with one of the subject matters of the invention, namely provided by the support arrangement according to the invention, the electric plug connector according to the invention, and the method according to the invention for assembling the plug connector, can also be advantageously implemented for the other subject matters of the invention. Similarly, advantages mentioned in connection with one of the subject matters of the invention can also be understood to refer to the other subject matters of the invention.

In addition, it should be noted that terms such as “comprising,” “having,” or “with” do not preclude other features or steps. Furthermore, terms like “a” or “the,” which refer to a singular number of steps or features, do not preclude a plurality of features or steps, and vice versa.

In a puristic embodiment of the invention, however, it can also be provided that the features introduced in the invention using the terms “comprising,” “having,” or “with” are listed exhaustively. Accordingly, one or multiple enumerations of features within the scope of the invention can be considered as final, for example viewed for each claim individually. The invention may, for example, consist exclusively of the features mentioned in claim 1.

It should be mentioned that designations such as “first” or “second” etc., are primarily used for distin-guishing respective device or method features and are not necessarily intended to imply that features are conditional upon one another or related to one another.

Furthermore, it should be emphasized that the values and parameters described herein include devia-tions or fluctuations of +10% or less, preferably +5% or less, more preferably +1% or less, and quite particularly preferably +0.1% or less of the value or parameter specified in each case, provided these devia-tions are not excluded when implementing the invention in practice. The indication of ranges by initial and final values also comprises all values and fractions encompassed by the range specified in each case, particularly the initial and final values and any respective mean value.

Exemplary embodiments of the invention are described in greater detail below with reference to the drawings.

The figures each show preferred exemplary embodiments in which individual features of the present invention are shown in combination with one another. Features of one exemplary embodiment can also be implemented independently of the other features of the same exemplary embodiment and can be readily combined accordingly by a person skilled in the art into further meaningful combinations and sub-combinations with features of other exemplary embodiments.

In the figures, functionally identical elements are provided with the same reference signs.

The drawings show schematically:

FIG. 1: a plan view of a plug connector with a support arrangement according to a first exemplary embodiment of the invention, focusing on the connection section of the plug connector;

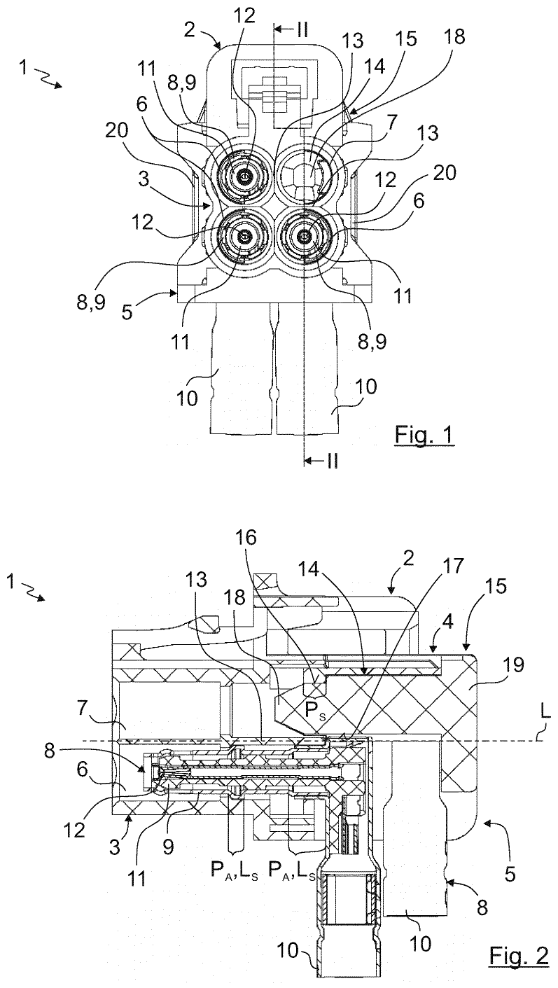

FIG. 2: a sectional view of the plug connector in the first exemplary embodiment along the sectional line II-II in FIG. 1;

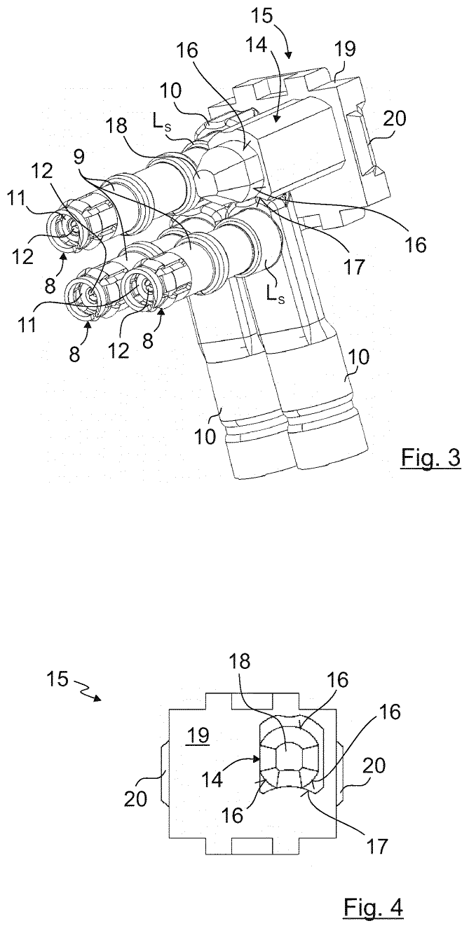

FIG. 3: the plug connector in the first exemplary embodiment with the plug connector housing hidden, in a perspective view,

FIG. 4: a plan view of the support arrangement of the plug connector in the first exemplary embodiment shown in an isolated view,

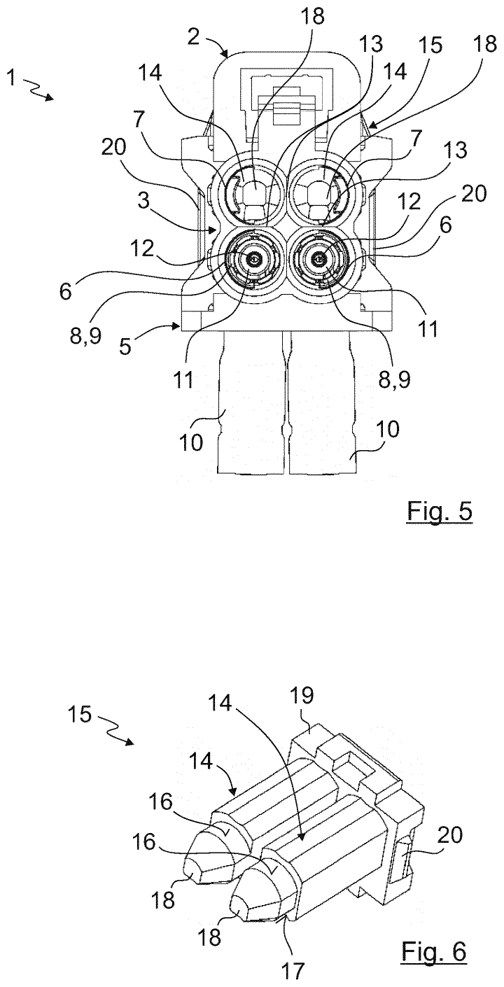

FIG. 5: a plan view of a plug connector with a support arrangement according to a second exemplary embodiment of the invention, focusing on the connection section of the plug connector; and

FIG. 6: a perspective view of an isolated representation of the support arrangement of the plug connector in the second exemplary embodiment.

FIGS. 1 to 4 show by way of example an exemplary embodiment of an electric plug connector 1 according to the invention. An angled cable plug connector 1 is shown by way of example; however, the invention is suitable in principle for use with any kinds of plug connectors and, in particular, should not be seen as limited to an angled plug connector, cable plug connector, or the coaxial design described below.

The plug connector 1 comprises a plug connector housing 2 made of plastic, which is formed in a front connection section 3 for electrical and mechanical connection to a corresponding mating plug connector that is not shown. Moreover, the plug connector 1 comprises a rear side 4 facing away from the connection section (cf. FIG. 2) and a cable outlet 5 arranged at an angle to the connection section 3.

Multiple chambers 6, 7 arranged side by side or parallel to one another extend through the plug connector housing 2, serving to receive respective contact elements 8 (cf. in particular FIG. 2 and FIG. 3). For high modularity and to apply the common parts principle in particularly economical manufacture in mass production for various applications, it is provided that some chambers 6 are equipped with a respective contact element 8 (“equipped chamber 6”) while other chambers 7 remain unequipped (“unequipped chamber 7”). For this purpose, all chambers 6, 7 of the plug connector housing 2 that can be equipped with contact elements 8 preferably have a functionally identical internal geometry. In the exemplary embodiment in FIGS. 1 to 4, three equipped chambers 6 and one unequipped chamber 7 are used (cf. in particular FIG. 1).

The invention is suitable in principle for use with any kinds of contact elements, which is why the coaxial design described below is to be understood as purely exemplary.

The contact element intended to equip the chambers 6, 7 in the exemplary embodiments is designed by way of example as an outer conductor contact element 8 with a predominantly sleeve-shaped structure. The outer conductor contact element 8 is designed as a two-part element for easier assembly and comprises a connection part 9 running primarily through the equipped chamber 6 for connection to a corresponding mating contact element of a mating plug connector, wherein a spring basket is formed at the front end of the connection part 9. For fastening to an electrical cable (not shown), the two-part outer conductor contact element 8 also has a cable outlet part 10 that is crimped to the connection part 9 (cf. in particular FIG. 3). The connection part 9 and the cable outlet part 10 are arranged at an angle to one another.

Within the outer conductor contact element 8 described, an insulator 11 is guided, through which an inner conductor contact element 12 runs (cf. in particular FIGS. 2 and 3). A coaxial contact arrangement is therefore provided in the individual equipped chambers 6. In principle, however, a simple contact element can also be provided.

In the assembled state (cf. in particular the sectional view in FIG. 2), a rigid longitudinal section L_{S} of the contact element 8 rests against an axial bearing position P_{A} or an axial bearing section on the inside of the equipped chamber 6. Multiple axial bearing positions P_{A} can also be provided, as indicated in FIG. 2.

Due to the connection between the connection part 9 and the cable outlet part 10, the outer conductor contact element 8 is particularly rigid or stiff in particular in the region of the rear axial bearing position P_{A}, which is why when lateral forces are transmitted from the cable to the contact element 8, in particular via this axial bearing position P_{A}, this can cause critical stress within the plug connector housing 2, potentially leading to damage or even a breakage of the common partition wall 13 between the equipped chamber 6 and the unequipped chamber 7. The connection region between the connection part 9 and the cable outlet part 10 of the outer conductor contact element 8 is therefore to be understood as a rigid longitudinal section L_{S}.

In order to increase the mechanical load capacity of the plug connector housing 2, it is proposed that adjacent to the at least one equipped chamber 6, a support element 14 of a support arrangement 15 is arranged in at least one further unequipped chamber 7 instead of a contact element 8, in order to support the unequipped chamber 7 on the inside at least at one axial support position P_{S} (cf. FIG. 2) that corresponds to the axial bearing position P_{A} of one of the adjacent contact elements 8 or at least partially over-laps with the axial bearing position P_{A} or an axial bearing section. The axial support position P_{S} in this case is therefore substantially arranged at the same axial position as the axial bearing position P_{A} of the adjacent equipped chamber 6 (relative to the longitudinal axis L of the plug connector housing 2).

It is proposed that preferably all chambers 6, 7 of the plug connector housing 2 are either equipped with a contact element 8 or include a support element 14.

It should be noted at this point that a support element 14 within the meaning of the invention is preferably not a contact element 8 or a “dummy” for a contact element 8. The outer geometry of the support element 14 is preferably different from the outer geometry of the at least one contact element 8 of the plug connector 1. Therefore, for example, the support element 14 does not have any connection means for direct fastening (e.g. latching) in one of the unequipped chambers 7 and, moreover, is also shorter in the exemplary embodiment than the contact element 8 of the plug connector 1. The support element 14 preferably extends only along a rear axial section into the unequipped chamber 7 so that, in the exemplary embodiment, the unequipped chamber 7 is supported primarily at an axial support position P_{S} opposite the rear bearing position P_{A} of the contact element 8, as shown in FIG. 2.

The support element 14 is preferably formed as a solid body and, in particular, made of a dielectric material, for example a plastic.

In order to fulfill the supporting function, the support element 14 has one or multiple support surfaces 16 arranged distributed along the circumference of the support element 14 for internal support of the unequipped chamber 7 (cf. in particular FIGS. 3 and 4), which are designed to bear against the inside of the unequipped chamber 7. It may also be provided in principle that the support element 14 provides full internal support to the unequipped chamber 7.

In addition, direct support of the support element 14 on the contact element 8 can be provided (cf. in particular FIGS. 2 and 3). For this purpose, at least one secondary support surface 17 can be used. This support can preferably take place outside the respective chamber 6, 7, further enhancing the mechanical properties of the plug connector 1.

For easier assembly, it can be provided that the cross section of the support element 14 decreases towards one of its ends (in the exemplary embodiment, the front end) to form a centering tip 18 for easier insertion of the support element 14 into the corresponding unequipped chamber 7. The centering tip 18 is preferably not fully pointed but has a blunt end.

Moreover, it can be provided that the at least one support element 14 extends from a plate-shaped base body 19 (cf. in particular FIGS. 3 and 4), from which it rises in a dome-like manner. For latching or fixing the support elements 14 in the individual unequipped chambers 7, the base body 19 has lateral latching elements 20 for latching with the plug connector housing 2. In this way, it is possible preferably to insert all the support elements 14 together, starting from the rear side 4 of the plug connector housing 2, into the unequipped chambers 7.

As can be seen from FIG. 2, in particular, the support elements 14, even when fully received in the assigned unequipped chambers 7, project towards the rear side 4 of the plug connector housing 2 from the respective unequipped chambers 7. This facilitates both assembly and dismantling.

As part of an advantageous manufacturing process for assembling the electrical connector 1, it can be provided that the connector housing 2 is first supplied and is then arbitrarily equipped with contact elements 8, wherein at least one of the chambers 6, 7 remains unequipped.

Finally, the support elements 14 described can be positioned in the unequipped chambers 7 instead of the contact elements 8 (preferably from the rear, as illustrated), so that the support element 14 internally supports the unequipped chamber 7, at least at an axial support position P_{S}, which at least substantially corresponds to an axial bearing position P_{A} of the adjacent equipped chamber 6. In this way, all unequipped chambers 7 are preferably equipped with a support element 14.

As previously mentioned, the plug connector 1 can be modularly, and therefore almost arbitrarily, equipped with contact elements 8 or left unequipped.

FIGS. 5 and 6 also show by way of example a second exemplary embodiment, in which only two chambers 6, 7 are equipped with contact elements 8, wherein the two unequipped chambers 7 are each fitted with a respective support element 14.

The support elements 14 shown in the exemplary embodiment in FIGS. 5 and 6 also extend starting from a plate-shaped base body 19, with which they are integrally formed (however, an integral design with the base body is not strictly necessary). In this way, a simultaneous assembly and fastening of the two support elements 14 can, in particular, be facilitated.

What is claimed is:

1. An electric plug connector, in particular an angled plug connector, comprising:
at least one electric contact element, a plug connector housing with multiple chambers running side by side that can be equipped with the contact elements, and a support arrangement,
wherein at least one of the chambers is equipped with one of the contact elements, so that a rigid longitudinal section of the contact element rests against the inner wall of the equipped chamber at an axial bearing position, and
wherein the support arrangement comprises at least one support element that can be inserted into an unequipped chamber of the plug connector housing instead of one of the contact elements, wherein adjacent to the at least one equipped chamber, the support element is arranged in at least one further unequipped chamber instead of a contact element, in order to support the unequipped chamber on the inside at least at one axial support position, wherein the axial support position is arranged at least substantially at the same axial position as the axial bearing position of the adjacent, equipped chamber.

2. The electric plug connector as claimed in claim 1, wherein the outer geometry of the support element is functionally different from the outer geometry of the at least one contact element of the plug connector, wherein the support element is particularly shorter along the longitudinal extent than the at least one contact element of the plug connector.

3. The electric plug connector as claimed in claim 1, wherein the cross section of the support element decreases towards one of its ends to form a centering tip for insertion of the support element into the associated unequipped chamber.

4. The electric plug connector as claimed in claim 1, wherein the support element is designed as a solid body and is made of a dielectric material.

5. The electric plug connector as claimed in claim 1, wherein the support element has one or multiple support surfaces arranged distributed along the circumference of the support element for supporting the unequipped chamber from the inside, which support surfaces are designed to rest against the inside of the unequipped chamber.

6. The electric plug connector as claimed in claim 1, further comprising a plate-shaped base body, from which the at least one support element rises in a dome-like manner, wherein the base body has at least one latching element for latching with the plug connector housing to hold the at least one support element in the unequipped chamber in a loss-proof manner.

7. The electric plug connector as claimed in claim 6, wherein multiple support elements rise from a common plate-shaped base body.

8. The electric plug connector as claimed in claim 1, wherein the support element stiffens the plug connector housing mechanically, in particular increases the transverse tensile strength of the plug connector housing, at least substantially comparably with a plug connector housing completely equipped with contact elements.

9. The electric plug connector as claimed in claim 1, wherein the at least one contact element is designed as an outer conductor contact element and has a primarily sleeve-shaped structure, at least in the rigid longitudinal section.

10. The electric plug connector as claimed in claim 1, wherein all chambers of the plug connector housing that can be equipped with contact elements have a functionally identical internal geometry.

11. The electric plug connector as claimed in claim 1, wherein all chambers of the plug connector housing that can be equipped with contact elements are either equipped with a contact element or have a support element.

12. The electric plug connector as claimed in claim 1, wherein the plug connector housing has a connection section for connecting to a corresponding mating plug connector, into which the chambers of the plug connector housing that can be equipped with contact elements open, wherein the support elements, starting from a rear side facing away from the connection section of the plug connector housing can be inserted into the chambers.

13. The electric plug connector as claimed in claim 12, wherein the support elements, when fully received in the assigned unequipped chambers, project towards the rear side of the plug connector housing from the respective unequipped chambers.

14. The electric plug connector as claimed in claim 1, wherein a respective chamber equipped with one of the contact elements and the unequipped chamber adjacent to this equipped chamber, which is supported on the inside by the support element, have a common partition wall separating both chambers.

15. A method for assembling an electric plug connector, in particular an angled plug connector, comprising at least the following method steps:
equipping at least one chamber of a plug connector housing with a contact element, so that a rigid longitudinal section of the contact element rests against at least one axial bearing position on the inside of the equipped chamber; and
positioning a support element instead of a contact element in at least one other, unequipped chamber adjacent to one of the equipped chambers, so that the support element supports the unequipped chamber on the inside at least at one axial support position, which at least substantially corresponds to the axial bearing position of the adjacent, equipped chamber.

16. The electric plug as claimed in claim 4, wherein the support body is made of plastic.
